(19) United States
(12) Patent Application Publication
(10) Pub. No.: US 2017/0309041 A1
(43) Pub. Date: Oct. 26, 2017

(54) METHOD AND APPARATUS FOR DERIVING INFORMATION ABOUT INPUT DEVICE USING MARKER OF THE INPUT DEVICE

(71) Applicant: ELECTRONICS AND TELECOMMUNICATIONS RESEARCH INSTITUTE, Daejeon (KR)

(72) Inventor: Ho-Chul SHIN, Daejeon (KR)

(73) Assignee: ELECTRONICS AND TELECOMMUNICATIONS RESEARCH INSTITUTE, Daejeon (KR)

(21) Appl. No.: 15/492,503

(22) Filed: Apr. 20, 2017

(30) Foreign Application Priority Data
Apr. 22, 2016 (KR) 10-2016-0049532

(51) Int. Cl. G06T 7/80; G06T 7/73; G06F 3/00

(52) U.S. Cl. CPC G06T 7/80; G06F 3/005; G06T 7/73; G06T 2207/10016; G06T 2207/10028; G06T 2207/30204; G06T 2207/10024

(57) ABSTRACT

Disclosed herein are a method and apparatus for deriving information about an input device using a marker thereof. Multiple cameras create multiple images by capturing the input device. A position recognition device derives the 3D positions of the markers of the input device using the multiple images and corrects information about the positions and angles of the multiple cameras based on the 3D positions of the markers. Also, the position recognition device derives the position and angle of the input device. The input device may comprise multiple input devices, and the multiple markers of the multiple input devices may be used to correct the information about the positions and angles of the multiple cameras depending on the coupling of the multiple input devices.

### CROSS REFERENCE TO RELATED APPLICATION

This application claims the benefit of Korean Patent Application No. 10-2016-0049532, filed Apr. 22, 2016, which is hereby incorporated by reference in its entirety into this application.

### BACKGROUND OF THE INVENTION

### 1. Technical Field

The present invention relates generally to a method and apparatus for deriving a position and, more particularly, to a method and apparatus for deriving information about an input device using the marker of the input device.

### 2. Description of the Related Art

With the advent of information technology, various input devices for inputting information into a computer system are being used. For example, a TV remote control, a game pad, a game controller, an interactive game remote control, and the like are used as such input devices.

Beyond merely providing a direction controller and buttons, such input devices may provide additional information to a computer system. For example, the movement of an input device or the absolute position thereof may be used as information from which the manipulation of the input device by a user may be derived in the computer system.

In order to detect the absolute position of an input device, an image captured using a camera may be used. That is, the image of the input device, captured using a camera, is analyzed, whereby the absolute position of the input device may be detected.

In order to detect the absolute position of an input device through image analysis, it is necessary to calibrate the position and angle of a camera. Generally, in order to calibrate the position and angle of a camera, a calibration board in the form of a checkerboard may be used. Specifically, when a calibration board is captured using a camera, the position of the camera may be calibrated based on the calibration board shown in the captured image.

With regard to calibration of the position of a camera, Korean Patent Application Publication No. 2013-0103577 has been disclosed.

### SUMMARY OF THE INVENTION

An embodiment may provide an apparatus and method for correcting the position and angle of a camera without the need to use a calibration board because a marker of an input device is used.

An embodiment may provide an apparatus and method for correcting the position and angle of a camera using markers of multiple input devices coupled in an attachable and detachable manner.

An embodiment may provide an apparatus and method in which the position and angle of a camera are corrected using an input device, which is manipulated in order to input information, whereby the amount of time and expense taken for the correction may be reduced and user convenience may be improved.

In one aspect, there is provided a position recognition method including creating multiple images by capturing an input device using multiple cameras; extracting 2D positions of multiple markers of the input device from each of the multiple images; deriving 3D positions of the multiple markers using the 2D positions of the multiple markers extracted from the each of the multiple images; and correcting information about a position and angle of each of the multiple cameras based on the derived 3D positions.

The position recognition method may further include deriving a position or an angle of the input device based on the 3D positions of the multiple markers.

The multiple markers may have different colors.

The input device may comprise multiple input devices.

The multiple input devices may include a left input device and a right input device.

The multiple input devices may be coupled to each other in an attachable and detachable manner.

The multiple markers attached to the multiple input devices may have different colors.

In another aspect, there is provided a position recognition device including a marker 2D position extraction unit for extracting 2D positions of multiple markers of an input device from each of multiple images created by capturing the input device; a marker 3D position estimation unit for deriving 3D positions of the multiple markers from the 2D positions of the multiple markers extracted from each of the multiple images; and a correction unit for correcting information about a position and angle of each of multiple cameras based on the derived 3D positions.

The position recognition device may further include an input device position/angle estimation unit for deriving a position or angle of the input device based on the 3D positions of the multiple markers.

The multiple markers may have different colors.

The input device may comprise multiple input devices.

The multiple input devices may be coupled to each other in an attachable and detachable manner.

In a further aspect, there is provided an electronic apparatus including an input device including multiple markers; multiple cameras for creating multiple images by capturing the input device; and a position recognition device for extracting 2D positions of the multiple markers of the input device from each of the multiple images, deriving 3D positions of the multiple markers from the 2D positions of the multiple markers, extracted from each of the multiple images, and correcting a position and angle of each of the multiple cameras based on the derived 3D positions.

The position recognition device may estimate a position or an angle of the input device based on the 3D positions of the multiple markers.

The multiple markers may have different colors.

The input device may comprise multiple input devices.

The multiple input devices may include a left input device and a right input device.

The multiple input devices may be coupled to each other in an attachable and detachable manner.

The multiple markers attached to the multiple input devices may have different colors.

The multiple cameras may be attached to a display at different positions thereof.

Additionally, other methods, devices, and systems for implementing the present invention and a computer-readable recording medium on which a computer program for performing the above method is recorded may be further provided.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows an electronic apparatus according to an embodiment;

FIG. 2 is a flowchart of a position recognition method according to an embodiment;

FIG. 3 shows the process of extracting markers of an input device according to an embodiment;

FIG. 4 shows coupling of multiple input devices according to an embodiment;

FIG. 5 shows the process of extracting markers of multiple input devices coupled to each other according to an embodiment; and

FIG. 6 shows a computer system for implementing an electronic apparatus according to an embodiment.

### DESCRIPTION OF THE PREFERRED EMBODIMENTS

Specific embodiments will be described in detail below with reference to the attached drawings. These embodiments are described in sufficient detail to enable those skilled in the art to practice the present invention. It should be understood that the embodiments differ from each other, but the embodiments do not need to be exclusive of each other. For example, a particular feature, structure, or characteristic described herein in connection with one embodiment may be implemented by another embodiment without departing from the sprit and scope of the present invention. Also, it should be understood that the location or arrangement of individual elements in the disclosed embodiments may be changed without departing from the spirit and scope of the present invention. Therefore, the following detailed description is not to be taken in a limiting sense, and if appropriately interpreted, the scope of the exemplary embodiments is limited only by the appended claims, along with the full range of equivalents to which the claims are entitled.

The same reference numerals are used to designate the same or similar elements throughout the drawings. The shapes, sizes, etc. of components in the drawings may be exaggerated to make the description clear.

The terms used herein are for the purpose of describing particular embodiments only and are not intended to be limiting of the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element, or intervening elements may be present.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

Also, element modules described in the embodiments of the present invention are independently shown in order to indicate different characteristic functions, but this does not mean that each of the element modules is formed of a separate piece of hardware or software. That is, element modules are arranged and included for convenience of description, and at least two of the element units may form one element unit or one element may be divided into multiple element units and the multiple element units may perform respective functions. An embodiment into which the elements are integrated or an embodiment from which some elements are removed is included in the scope of the present invention, as long as it does not depart from the essence of the present invention.

Also, in the present invention, some elements are not essential elements for performing essential functions, but may be optional elements for improving only performance. The present invention may be implemented using only essential elements for implementing the essence of the present invention, excluding elements used to improve only performance, and a structure including only essential elements, excluding optional elements used only to improve performance, is included in the scope of the present invention.

Hereinafter, embodiments of the present invention are described with reference to the accompanying drawings in order to describe the present invention in detail so that those having ordinary knowledge in the technical field to which the present invention pertains can easily practice the present invention. In the following description of the present invention, detailed descriptions of known functions and configurations which are deemed to make the gist of the present invention obscure will be omitted.

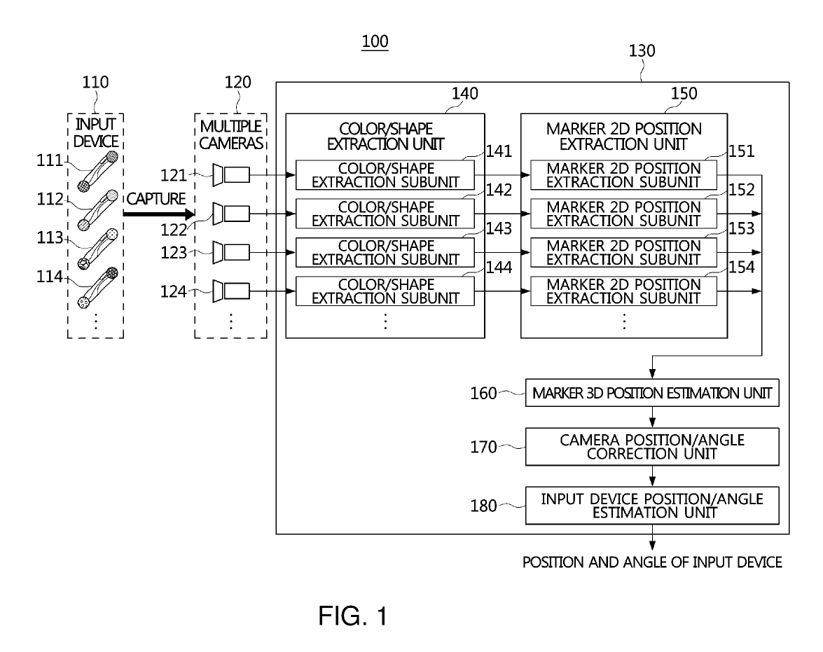

FIG. 1 shows an electronic apparatus according to an embodiment.

The electronic apparatus 100 may include an input device 110, multiple cameras 120, and a position recognition device 130.

The input device 110 may comprise multiple input devices. As examples of the multiple input devices, four input devices 111, 112, 113 and 114 are illustrated.

Also, as examples of the multiple cameras 120, four cameras 121, 122, 123 and 124 are illustrated.

The position recognition device 130 may include a color/shape extraction unit 140, a marker 2D position extraction unit 150, a marker 3D position estimation unit 160, a camera position/angle correction unit 170, and an input device position/angle estimation unit 180.

The color/shape extraction unit 140 may include multiple color/shape extraction subunits. As examples of the multiple color/shape extraction subunits, four color/shape extraction subunits 141, 142, 143 and 144 are illustrated.

The marker 2D position extraction unit 150 may include multiple marker 2D position extraction subunits. As examples of the multiple marker 2D position extraction subunits, four marker 2D position extraction subunits 151, 152, 153 and 154 are illustrated.

The functions and operations of the input device 110, the multiple cameras 120, and the position recognition device 130 will be described in detail below.

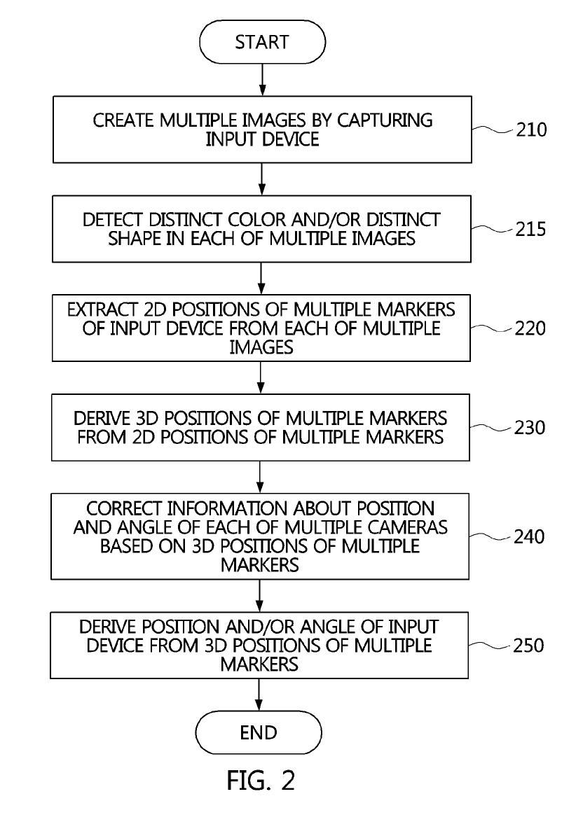

FIG. 2 is a flowchart of a position recognition method according to an embodiment.

At step 210, the multiple cameras 120 may create multiple images by capturing the input device 110. That is, multiple images may be created by capturing the input device 110 using the multiple cameras 120. The image captured using each of the multiple cameras 120 may include the image of the input device 110. Also, the shape of the input device 110 shown in the captured image may reflect the position or angle of the camera.

The input devices 110 may include multiple markers. For example, the multiple markers may be attached to the input devices 110.

The multiple markers may be distinguished from each other. For example, the multiple markers may have different colors. Alternatively, the multiple markers may have different patterns.

At step 215, the color/shape extraction unit 140 may detect a distinct color and/or a distinct shape in each of the multiple images.

Here, the distinct color may be the colors of the multiple markers. The distinct shape may be the shape of the input device 110 or the shapes of the multiple markers. The distinct color and/or the distinct shape, extracted from the image, may be the color and/or shape to be used to extract the 2D positions of the multiple markers at step 220, which will be described later.

The multiple color/shape extraction subunits may detect a distinct color and/or a distinct shape in the multiple images, respectively. For example, in order to detect a distinct color and/or a shape in each of the multiple images, a corresponding one of the color/shape extraction subunits may be provided.

At step 220, the marker 2D position extraction unit 150 may extract the 2D positions of the multiple markers of the input device 110 from each of the multiple images.

When extracting the 2D positions of the multiple markers, the marker 2D position extraction unit 150 may use the distinct color and/or the distinct shape, detected at step 215. The marker 2D position extraction unit 150 may set the position corresponding to the distinct color and/or the distinct shape of each of the multiple markers as the position of the corresponding marker.

The multiple marker 2D position extraction subunits may extract the 2D positions of the multiple markers of the input device 110 from the multiple images. For example, in order to extract the 2D positions of the multiple markers of the input device 110 from each of the multiple images, a corresponding one of the marker 2D position extraction subunits may be provided.

At step 230, the marker 3D position estimation unit 160 may acquire the 3D positions of the multiple markers using the 2D positions of the multiple markers extracted from each of the multiple images.

The marker 3D position estimation unit 160 may derive the 3D positions of the multiple markers using various existing methods and/or algorithms for deriving 3D positions.

The multiple marker 2D position extraction subunits may provide the marker 3D position estimation unit 160 with the 2D positions of the multiple markers, extracted from each of the images.

At step 240, the camera position/angle correction unit 170 may correct information about the positions and angles of the multiple cameras 120 based on the 3D positions of the multiple markers.

The position recognition device 130 may contain information about the multiple cameras 120. The information about the multiple cameras 120 may include the position and angle of each of the multiple cameras 120. Here, the term “angle” may be interchangeable with the term “orientation”.

When an image including an object is captured using a camera, information about the position and angle of the camera is required in order to acquire the position of the object using the captured image. However, when the position of the object is estimated using the information about the position and angle of the camera contained in the position recognition device 130, there may be a difference between the estimated position and the actual position of the object. In order to eliminate or decrease this difference, it is necessary to correct the information about the position and angle of the camera. That is, the information about the position and angle of the camera contained in the position recognition device 130 must be adjusted so as to accurately derive the position of the object. Such a difference may result from the characteristics of the camera itself, or may result from the incorrectness of the position and angle of the camera.

Through the correction, the position value and the angle value of the camera may be adjusted or updated. Alternatively, through the correction, the values of one or more parameters related to the position and/or angle of the camera may be set. The one or more parameters may be managed by the position recognition device 130, or may be managed by the camera itself.

The 3D positions of the multiple markers may mean points in 3D space. The camera position/angle correction unit 170 may correct information about the positions and angles of the multiple cameras 120 using the existing methods and/or algorithms for correcting information about the position and angle of a camera based on the coordinates of the points in 3D space.

At step 250, the input device position/angle estimation unit 180 may derive the position and/or angle of the input device 110 based on the 3D positions of the multiple markers.

The position and/or angle of the input device 110 may be the absolute position and/or the absolute angle.

When deriving the position and/or angle of the input device 110, the input device position/angle estimation unit 180 may use information about the position and angle of each of the multiple cameras 120.

The 3D positions of the multiple markers may mean points in 3D space. The input device position/angle estimation unit 180 may derive the position and/or angle of the input device 110 using methods and/or algorithms for calculating the position and/or angle of the input device based on the coordinates of the points in 3D space.

The above-described steps 210, 215, 220, 230, 240 and 250 may be repeatedly performed. For example, step 240 may be performed only in the first run, when the steps 210, 215, 220, 230 and 250 are repeatedly performed. Alternatively, step 240 may be performed only in a run selected based on predefined criteria when the steps 210, 215, 220, 230 and 250 are repeatedly performed. In other words, the correction of the information about the positions and angles of the multiple cameras 120 at step 240 may be selectively performed.

The position and/or angle of the input device 110, created through the above-described steps 210, 215, 220, 230, 240 and 250, may be provided to other program modules or other devices. That is, the position recognition method may provide the position and/or angle of the input device 110 to a program module, an Application Programming Interface (API), a hardware module, and the like.

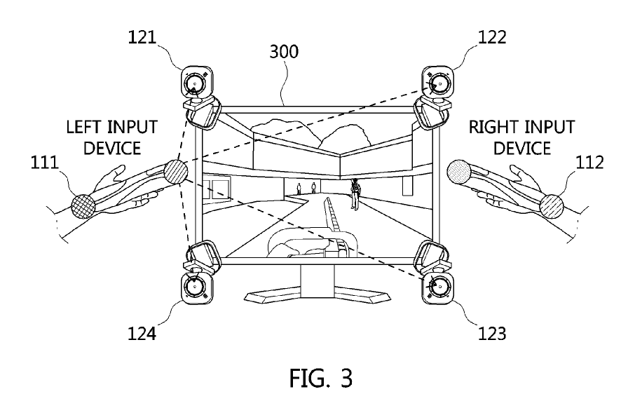

FIG. 3 describes the process of extracting markers of an input device according to an embodiment.

The input device 110 may comprise multiple input devices. FIG. 3 shows a left input device 111 and a right input device 112 as examples of the multiple input devices. As illustrated in the drawing, the multiple input devices may include the left input device 111 and the right input device 112. The left input device 111 may be an input device manipulated by a user of the electronic apparatus 100 using his or her left hand. The right input device 112 may be an input device manipulated by the user of the electronic apparatus 100 using his or her right hand.

The multiple cameras 120 may be attached to the display 300 at different positions thereof. For example, the multiple cameras 120 may be arranged near the four corners of the display 300. FIG. 3 shows the four cameras 121, 122, 123 and 124 arranged at the four corners of the display 300.

FIG. 3 shows an example in which multiple cameras 120 capture a single input device 110. For example, the above-described steps 210, 215, 220, 230, 240 and 250 may be applied to the left input device 111 and/or the multiple markers of the left input device 111.

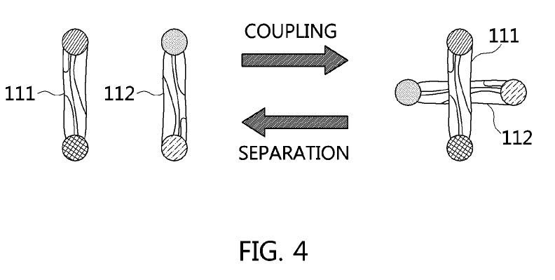

FIG. 4 describes the coupling of the multiple input devices according to an embodiment.

As illustrated in FIG. 3, when the multiple input devices are individually manipulated, the multiple cameras 120 may not capture all of the multiple input devices.

The multiple input devices may be coupled to each other in a detachable manner. To this end, each of the multiple input devices may include a member for coupling. For example, the member for coupling may include a magnet, a member having an adhesive property or a member capable of being attached to and detached from another.

The multiple input devices may realize a predefined form by being coupled to each other. For example, the multiple input devices may be coupled crosswise to each other. The markers of the multiple input devices may be arranged crosswise by coupling the multiple input devices crosswise to each other.

FIG. 4 shows a cross-shaped input device, which is formed by coupling the two input devices 111 and 112 crosswise to each other. Also, the cross-shaped input device may be separated again into the two input devices 111 and 112.

When the multiple input devices are coupled, the coupled multiple input devices may be used for the correction at step 240. Also, when the multiple input devices are separate, each of the multiple separate input devices may be used to derive the position and/or angle of the input device 110 at step 250. That is, each of the input devices may be used for a common purpose of input.

As the multiple input devices are coupled, the markers of the coupled multiple input devices may provide information required for the correction of information about the position and angle of the camera. Therefore, the information about the position and angle of the camera may be corrected without a calibration board.

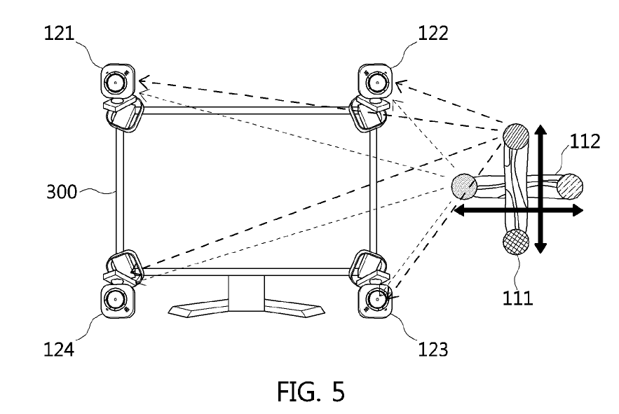

FIG. 5 describes the process of extracting the markers of multiple input devices coupled to each other according to an embodiment.

The multiple input devices, coupled through coupling, may be captured using the multiple cameras 120. FIG. 5 shows an example in which the cross-shaped input device formed by coupling the two input devices 111 and 112 is captured using the four cameras 121, 122, 123 and 124.

As the multiple input devices are captured, the multiple markers of the multiple input devices may be used for the position recognition method described above with reference to FIG. 2.

The above-described steps 210, 215, 220, 230, 240 and 250 may be used for the multiple (coupled) input devices and/or the multiple markers of the multiple (coupled) input devices.

When the multiple input devices and/or the multiple markers of the multiple input devices are used at the above-described steps 210, 215, 220, 230, 240 and 250, the correction at step 240 and deriving of the position and/or angle of the input device at step 250 may output a more accurate result.

In order to enable the detection of the markers, the multiple markers of the multiple input devices may be distinguished from each other. For example, the multiple markers of the multiple input devices may have different colors. In FIG. 5, the multiple markers of the multiple input devices are depicted as having different patterns.

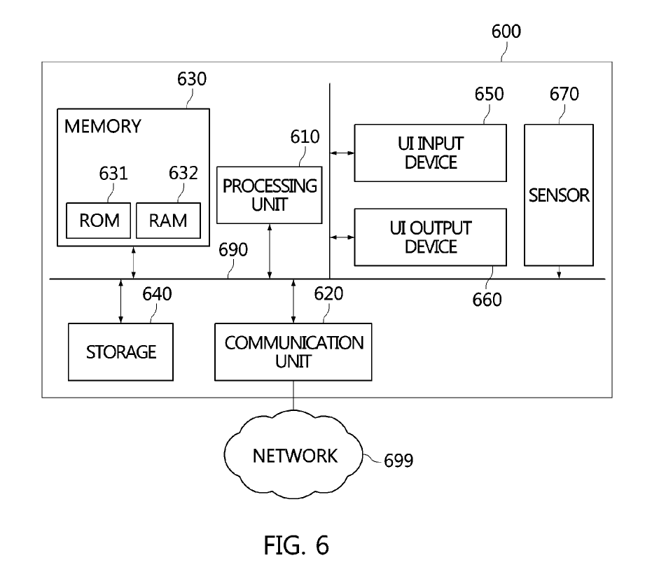

FIG. 6 shows a computer system for implementing an electronic apparatus according to an embodiment.

The electronic apparatus 100 may be implemented as the computer system 600 illustrated in FIG. 6.

As shown in FIG. 6, the computer system 600 may include at least some of a processing unit 610, a communication unit 620, memory 630, storage 640, and a bus 690. The components of the computer system 600, such as the processing unit 610, the communication unit 620, the memory 630, the storage 640, and the like, may communicate with each other via the bus 690.

The processing unit 610 may be a semiconductor device for executing processing instructions stored in the memory 630 or the storage 640. For example, the processing unit 610 may be at least one processor.

The processing unit 610 may execute a process required for the operation of the computer system 600. The processing unit 610 may execute code corresponding to the operation of the processing unit 610 or the steps described in the embodiments.

The processing unit 610 may create, store and output information to be described in the following embodiment, and may perform the operation of steps performed in other computer system 600.

At least some of the color/shape extraction unit 140, the marker 2D position extraction unit 150, the marker 3D position estimation unit 160, the camera position/angle correction unit 170, and the input device position/angle estimation unit 180, described above with reference to FIG. 1, may be program modules, and may communicate with an external device or system. Also, program modules in the form of an Operation System (OS), an application module, and other program modules may be included in the computer system 600.

The program modules may be physically stored in various known memory devices. Also, at least some of these program modules may be stored in a remote memory device capable of communicating with the computer system 600.

The program modules may perform a function or operation according to an embodiment, or may include a routine, a subroutine, a program, an object, a component, a data structure and the like for implementing an abstract data type according to an embodiment, but the program modules are not limited thereto.

The program modules may be configured with instructions or code, executed by the processing unit 610. The function or operation of the computer system 600 may be performed when the processing unit 610 executes at least one program module. The at least one program module may be configured to be executed by the processing unit 610.

The multiple color/shape extraction subunits may be an execution unit such as a thread or a process. The multiple color/shape extraction subunits may be created and destroyed as needed. Also, multiple color/shape extraction subunits may be executed in parallel. Through such parallel execution of multiple color/shape extraction subunits, the extraction of colors and shapes from multiple images may be simultaneously performed.

The multiple marker 2D position extraction subunits may be an execution unit such as a thread or a process. The multiple marker 2D position extraction subunits may be created and destroyed as needed. Also, multiple marker 2D position extraction subunits may be executed in parallel. Through such parallel execution of the multiple marker 2D position extraction subunits, the extraction of the positions of the markers from the multiple images may be simultaneously performed.

The communication unit 620 may be connected to a network 699. The communication unit 620 may receive data or information required for the operation of the computer system 600, and may send data or information required for the operation of the computer system 600. The communication unit 620 may send data to other devices and receive data from other devices via the network 699. For example, the communication unit 620 may be a network chip or port.

The memory 630 and the storage 640 may be various forms of volatile or non-volatile storage media. For example, the memory 630 may include at least one of ROM 631 and RAM 632. The storage 640 may include an internal storage medium such as RAM, flash memory, a hard disk, and the like, and may include a detachable storage medium such as a memory card or the like.

The memory 630 and/or the storage 640 may store at least one program module.

The computer system 600 may further include a user interface (UI) input device 650 and a UI output device 660. The UI input device 650 may receive user input required for the operation of the computer system 600. The UI output device 660 may output information or data depending on the operation of the computer system 600.

The computer system 600 may further include a sensor 670. The sensor 670 may correspond to the multiple cameras 120, described above with reference to FIG. 1.

The apparatus described herein may be implemented using hardware components, software components, or a combination thereof. For example, the apparatus and components described in the embodiments may be implemented using one or more general-purpose or special purpose computers, for example, a processor, a controller, an arithmetic logic unit (ALU), a digital signal processor, a microcomputer, a field programmable array (FPA), a programmable logic unit (PLU), a microprocessor or any other device capable of responding to and executing instructions. The processing device may run an operating system (OS) and one or more software applications that run on the OS. The processing device may also access, store, manipulate, process, and create data in response to execution of the software. For convenience of understanding, the use of a single processing device is described, but those skilled in the art will understand that a processing device may comprise multiple processing elements and multiple types of processing elements. For example, a processing device may include multiple processors or a single processor and a single controller. Also, different processing configurations, such as parallel processors, are possible.

The software may include a computer program, code, instructions, or some combination thereof, and it is possible to configure processing devices or to independently or collectively instruct the processing devices to operate as desired. Software and data may be embodied permanently or temporarily in any type of machine, component, physical or virtual equipment, computer storage medium or device, or in a propagated signal wave in order to provide instructions or data to the processing devices or to be interpreted by the processing devices. The software may also be distributed in computer systems over a network such that the software is stored and executed in a distributed method. In particular, the software and data may be stored in one or more computer-readable recording media.

The method according to the above-described embodiments may be implemented as a program that can be executed by various computer means. In this case, the program may be recorded on a computer-readable storage medium. The computer-readable storage medium may include program instructions, data files, and data structures, either solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

Because the marker of an input device itself is used, an apparatus and method for correcting the position and angle of a camera without the need to use a calibration board are provided.

The apparatus and method for correcting the position and angle of a camera using markers of multiple input devices, which are coupled to each other in an attachable and detachable manner, are provided.

The apparatus and method in which the position and angle of a camera is corrected using an input device, which is manipulated so as to perform input, are provided, whereby the amount of time and expense taken for the correction may be reduced and user convenience in performing the correction may be improved.

Although the embodiments of the present invention have been disclosed for illustrative purposes, those skilled in the art will appreciate that various modifications, additions and substitutions are possible, without departing from the scope and spirit of the invention. For example, if the described techniques are performed in a different order, if the described components, such as systems, architectures, devices, and circuits, are combined or coupled with other components by a method different from the described methods, or if the described components are replaced with other components or equivalents, the results are still to be understood as falling within the scope of the present invention.

What is claimed is:

1. A position recognition method, comprising:
by at least one processor,
creating multiple images by capturing images of an input device using multiple cameras;
extracting 2D positions of multiple markers of the input device from the multiple images;
deriving 3D positions of the multiple markers using the 2D positions of the multiple markers extracted from the multiple images; and
correcting information about a position and angle of at least one of the multiple cameras based on at least one of the derived 3D positions.

2. The position recognition method of claim 1, further comprising:
by the at least one processor deriving a position or an angle of the input device based on the 3D positions of the multiple markers.

3. The position recognition method of claim 1, wherein the multiple markers have different colors.

4. The position recognition method of claim 1, wherein the input device comprises multiple input devices.

5. The position recognition method of claim 4, wherein the multiple input devices include a left input device and a right input device.

6. The position recognition method of claim 4, wherein the multiple input devices are coupled to each other in an attachable and detachable manner.

7. The position recognition method of claim 4, wherein the multiple markers attached to the multiple input devices have different colors.

8. A position recognition device, comprising:
at least one processor; and
at least one memory that stores instructions, which when executed by the at least one processor, cause the at least one processor to execute:
extracting 2D positions of multiple markers of an input device from multiple images created by multiple cameras capturing the input device;
deriving 3D positions of the multiple markers from the 2D positions of the multiple markers extracted from the multiple images; and
correcting information about a position and angle of at least one of the multiple cameras based on the derived 3D positions.

9. The position recognition device of claim 8, wherein the stored instructions further cause the at least one processor to derive a position or angle of the input device based on the 3D positions of the multiple markers.

10. The position recognition device of claim 8, wherein the multiple markers have different colors.

11. The position recognition device of claim 8, wherein the input device comprises multiple input devices.

12. The position recognition device of claim 11, wherein the multiple input devices are coupled to each other in an attachable and detachable manner.

13. An electronic apparatus, comprising:
an input device including multiple markers;
multiple cameras to create multiple images by capturing the input device; and
a position recognition device including at least one processor to control,
extracting 2D positions of the multiple markers of the input device from the multiple images,
deriving 3D positions of the multiple markers from the 2D positions of the multiple markers, extracted from the multiple images, and
correcting a position and angle of at least one of the multiple cameras based on the derived 3D positions.

11. The electronic apparatus of claim 13, wherein the position recognition device estimates a position or an angle of the input device based on the 3D positions of the multiple markers.

15. The electronic apparatus of claim 13, wherein the multiple markers have different colors.

16. The electronic apparatus of claim 13, wherein the input device comprises multiple input devices.

17. The electronic apparatus of claim 16, wherein the multiple input devices include a left input device and a right input device.

18. The electronic apparatus of claim 16, wherein the multiple input devices are coupled to each other in an attachable and detachable manner.

19. The electronic apparatus of claim 16, wherein the multiple markers attached to the multiple input devices have different colors.

20. The electronic apparatus of claim 13, wherein the multiple cameras are attached to a display at different positions thereof.
